(19) United States
(12) Patent Application Publication
(10) Pub. No.: US 2018/0112427 A1
(43) Pub. Date: Apr. 26, 2018

(54) COATED PAPERBOARD FOR TEMPORARY ROOF PATCH

(71) Applicant: INTERNATIONAL PAPER COMPANY, Memphis, TN (US)

(72) Inventors: April Nicole Bryan, Memphis, TN (US); Lawrence Richard Pestcoe, Landisville, PA (US); Scott Eric Kibler, East Petersburg, PA (US); David Eugene Phillips, JR., Haughton, LA (US)

(73) Assignee: INTERNATIONAL PAPER COMPANY Memphis, Memphis, TN (US)

(21) Appl. No.: 15/334,651

(22) Filed: Oct. 26, 2016

(51) Int. Cl. E04G 23/02; B05D 1/02; B05D 1/18

(52) U.S. Cl. CPC E04G 23/0281; B05D 1/18; B05D 1/02

(57) ABSTRACT

A coated paperboard having a top ply, intermediate plies, and base ply all of which are laminated to one another with a moisture resistant adhesive wherein two respective outside top and base plies are coated with a water or moisture resistant coating so that the coated paperboard is capable of being used as a temporary roofing patch for a damaged roof.

### FIELD OF THE INVENTION

The present invention broadly relates to water-repellent coated paperboard substrates suitable for temporary roof patching.

### BACKGROUND AND SUMMARY OF THE INVENTION

A roof is a system of multiple materials, layered together. The first layer is wood sheathing, followed by felt roofing underlayment, also called tar sheet or paper, followed by overlapping asphalt shingles. Although roofs are very durable, high winds and hail can sometimes damage them. Places that hit by tornadoes or hurricanes may experience damaged buildings that cannot be repaired for many weeks due to the amount of carnage and lack of labor resources. Generally, a damaged roof is currently covered with a commonly used blue tarpaulins or blue tarps until the damaged section can be repaired permanently or alternatively, a heavyweight tar sheet or paper is temporary used. The commonly used blue tarpaulins or tarps and/or plywood are hard to handle and attach, requiring 2″×4″ wood beam to hold them in place. With the tarpaulin and wood, generally, it requires more than one person to patch the hole safely. Oftentimes because of safety, speed, or convenience, a much larger tarpaulin is used than necessary, so a great amount of waste and extra cost.

Therefore, it would be desirable to provide a temporary roof patching, which is easy to install, it is safe, and it does not increase material and/or manufacturing costs.

Until now, almost all of the grades coated paperboards have been used in making containers, cups, slip sheets, tier sheets, and the pallet sheets that are used for various purposes except the purpose or function of coated paperboard disclosed by the claimed invention. However, the present invention is directed to a coated paperboard that can be used for temporary roof patching as an alternative to the commonly used tarpaulin for patching roofs which provide temporary coverage after storms or during renovations. The coated paperboard temporary roof patch only requires roof nails to attach and is approximately 40″×48″ in size to avoid waste, make it easier to apply, less costly, and it is safer. It should be noted that the 40″×48″ is an exemplary size and other sizes and dimensions are within the scope of the invention. The coated paperboard temporary patch is a solid fiber substrate or liners laminated together with a moisture resistant adhesive. The two respective outside top and bottom liners are coated with a moisture resistant coating and tinted to blend with roofs as best as possible. The coated paperboard temporary roof patch is attached with roof nails three shingles above the hole and with at least four inches of coverage around the hole on the other sides. It prevents water and other elements from entering the home/structure by patching the hole for a temporary period of time, such as for example, up to 60 days. The field testing and lab tests with coated paperboard show remarkable results. Inventors discovered that product that is paper-based and specific to the roofing industry is superior to the commonly used tarpaulins or tarps. Because of the moisture resistant adhesives used in the laminating process and the water repellent coatings on the outside of the paperboard patch, the paperboard patch performs like a shingle and keep the water/moisture out of a home or other structure. Some of the notable advantages of the temporary paperboard roof patch are: safety, ease of use/handling, reduced waste, less costs, less labor/time to apply, ease of disposal, and biodegradable as opposed to petroleum based raw material such as tarpaulins or tarps.

### BRIEF DESCRIPTION OF THE DRAWINGS

The invention will be described in conjunction with the accompanying drawings, in which:

FIG. 1 represents a cross-sectional view of a multi-ply paperboard in accordance to the present invention;

FIG. 2 a pictorial view of a temporary roofing patch in accordance to the present invention in use; and

### DETAILED DESCRIPTION

It is advantageous to define several terms before describing the invention. It should be appreciated that the following definitions are used throughout this application.

### Definitions

Where the definition of terms departs from the commonly used meaning of the term, applicant intends to utilize the definitions provided below, unless specifically indicated.

For the purpose of the present invention, solid fiber substrate is made from multiple plies of Kraft linerboard laminated together using a water/moisture resistant adhesive. It is recyclable and sourced from 100% renewable forest fiber making it a smart environmental choice. Solid fiber products are designed to be stronger and more moisture resistant than corrugated packaging and as a cost savings replacement for packaging materials such as wood, rubber, plastic or styrofoam.

For the purposes of the present invention, the term “paper substrate” refers to a fibrous paper web that may be formed, created, produced, etc., from a mixture, furnish, etc., comprising paper fibers, internal sizing agents, etc., plus any other optional papermaking additives such as, for example, paper fillers, wet-strength agents, optical brightening agents, etc. The paper substrate may be in the form of a continuous roll, a discrete sheet, etc.

For the purposes of the present invention, the term “paper fibers” refers to any fibrous material which may be used in preparing a fibrous paper web. Paperboard making fibers may include pulp (wood) fibers (e.g., softwood fibers and/or hardwood fibers), kraft fibers (e.g., pulp fibers produced by the kraft pulping process), as well as wood fibers produced by soda, sulfite, magnefite, cold soda, NSSC, etc., pulp making processes, synthetic fibers, waste paper fibers, recycled paper fibers, fibers from any of hemp, jute, ramie, flax, cotton linters, abaca, wood waste, straw, bagasse, bamboo, sisal, synthetic (e.g., bicomponent) fibers, etc., as well as any combinations of such fibers.

For the purposes of the present invention, the term “paperboard” refers to paper substrate comprising a single ply (layer) of a paperboard having a caliper of from about 8 to about 28 mils (points), such as from about 9 to about 12 mils (points). The paperboard may be in the form of a continuous roll, a discrete sheet, a packaging material blank such as for making a cup, etc.

For the purposes of the present invention, the term laminate refers to means of two or more plies are bonded to one another by methods known in the art, for example, adhesive bonding, thermal bonding, and/or ultrasonic bonding.

For the purposes of the present invention, the term “softwood fibers” refers to fibrous pulps derived from the woody substance of coniferous trees (gymnosperms) such as varieties of fir, spruce, pine, etc., for example, loblolly pine, slash pine, Colorado spruce, balsam fir, Douglas fir, jack pine, radiata pine, white spruce, lodgepole pine, redwood, etc. North American southern softwoods and northern softwoods may be used to provide softwood fibers, as well as softwoods from other regions of the world. Inclusion of softwood fibers tends to impart greater bending stiffness in paper substrates such as paperboards, but also tends to impart rougher and less smooth surfaces in paper substrates, such as paperboards.

For the purposes of the present invention, the term “hardwood fibers” refers to fibrous pulps derived from the woody substance of deciduous trees (angiosperms) such as birch, oak, beech, maple, eucalyptus, poplars, etc. Inclusion of hardwood fibers in paper substrates such as paperboards tends to impart smoother surfaces in paper substrates, such as paperboards.

For the purposes of the present invention, the term “CTMP fibers” refers to chemithermomechanical pulp (CTMP) fibers which have subjected to a combination of chemical, thermal, and mechanical treatment. As used herein, CTMP fibers refer to fibers which have been treated by chemical, thermal, and mechanical treatment in any order of such treatments, including chemi-thermo-mechanical (C-T-M) pulp fibers, thermo-chemi-mechanical (T-C-M) pulp fibers, thermo-mechanical-chemi (T-M-P) pulp fibers, long fiber chemi-mechanical pulp/chemically treated long pulp fibers (LFCMP/CTLF), etc. See G. A. Smook, Handbook for Pulp and Paper Technologists (2^{nd} Edition, 1992), pages 60-65, the entire contents and disclosure of which is herein incorporated by reference, for a general description of chemithermomechanical pulping (CTMP) for preparing CTMP fibers.

For the purposes of the present invention, the term “bleached CTMP fibers (also referred to interchangeably as BCTMP fibers” refers to chemithermomechanical pulp (CTMP) fibers which have subjected to one or more bleaching treatments.

For the purposes of the present invention, the term “synthetic fibers” refers to fibers other than wood pulp fibers (e.g., other than pulp fibers) and which may be made from, for example, cellulose acetate, acrylic, polyamides (such as, for example, Nylon 6, Nylon 6/6, Nylon 12, polyaspartic acid, polyglutamic acid, etc.), polyamines, polyimides, polyamides, polyacrylics (such as, for example, polyacrylamide, polyacrylonitrile, esters of methacrylic acid and acrylic acid, etc.), polycarbonates (such as, for example, polybisphenol A carbonate, polypropylene carbonate, etc.), polydienes (such as, for example, polybutadiene, polyisoprene, polynorbomene, etc.), polyepoxides, polyesters (such as, for example, polyethylene terephthalate, polybutylene terephthalate, polytrimethylene terephthalate, polycaprolactone, polyglycolide, polylactide, polyhydroxybutyrate, polyhydroxyvalerate, polyethylene adipate, polybutylene adipate, polypropylene succinate, etc.), polyethers (such as, for example, polyethylene glycol(polyethylene oxide), polybutylene glycol, polypropylene oxide, polyoxymethylene(paraformaldehyde), polytetramethylene ether(polytetrahydrofuran), polyepichlorohydrin, and so forth), polyfluorocarbons, formaldehyde polymers (such as, for example, urea-formaldehyde, melamine-formaldehyde, phenol formaldehyde, etc.), polyolefins (such as, for example, polyethylene, polypropylene, polybutylene, polybutene, polyoctene, etc.), polyphenylenes (such as, for example, polyphenylene oxide, polyphenylene sulfide, polyphenylene ether sulfone, etc.), silicon containing polymers (such as, for example, polydimethyl siloxane, polycarbomethyl silane, etc.), polyurethanes, polyvinyls (such as, for example, polyvinyl butyral, polyvinyl alcohol, esters and ethers of polyvinyl alcohol, polyvinyl acetate, polystyrene, polymethylstyrene, polyvinyl chloride, polyvinyl pyrrolidone, polymethyl vinyl ether, polyethyl vinyl ether, polyvinyl methyl ketone, etc.), polyacetals, polyarylates, and copolymers (such as, for example, polyethylene-co-vinyl acetate, polyethylene-co-acrylic acid, polybutylene terephthalate-co-polyethylene terephthalate, polylauryllactam-block-polytetrahydrofuran, vinyl chloride, regenerated cellulose such as viscose rayon, glass fibers, ceramic fibers, bicomponent fibers, melamine fibers (e.g., fibers obtained from melamine-formaldehyde resin), etc.

For the purposes of the present invention, the term “bicomponent fibers” refers to synthetic fibers comprising a core and sheath configuration. The core and sheath portions of these bicomponent fibers may be made from various polymers. For example, bicomponent fibers may comprise a PE (polyethylene) or modified PE sheath which may have a PET (polyethylene terephthalate) or PP (polypropylene) core. In one embodiment, the bicomponent fiber may have a core made of polyester and sheath made of polyethylene. Alternatively, a multi-component fiber with a PP (polypropylene) or modified PP or PE sheath or a combination of PP and modified PE as the sheath or a copolyester sheath wherein the copolyester is isophthalic acid modified PET (polyethylene terephthalate) with a PET or PP core, or a PP sheath-PET core and PE sheath-PP core and co-PET sheath fibers may be employed. Various geometric configurations may be used for the bicomponent fiber, including concentric, eccentric, islands-in-the-sea, side-by-side, etc. The relative weight percentages and/or proportions of the core and sheath portions of the bicomponent fiber may also be varied.

For the purposes of the present invention, the term “paper filler” refers to inorganic materials, which may be in particulate form, which may lower the cost (per weight) of the paper substrate, etc. Paper fillers which may used in embodiments of the present invention may include, for example, calcium carbonate, magnesium carbonate, calcium hydroxide, calcium aluminate, magnesium carbonate mica, silica, alumina, sand, gravel, sandstone, limestone, crushed rock, bauxite, granite, limestone, glass beads, aerogels, xerogels, fly ash, fumed silica, fused silica, tabular alumina, kaolin, microspheres, hollow glass spheres, porous ceramic spheres, ceramic materials, pozzolanic materials, zirconium compounds, xonotlite (a crystalline calcium silicate gel), lightweight expanded clays, perlite, vermiculite, hydrated or unhydrated hydraulic cement particles, pumice, zeolites, exfoliated rock, etc., and mixtures thereof. Certain paper fillers such as calcium carbonate, may also function as paper pigments.

For the purposes of the present invention, the term “internal paper sizing agents” refers to sizing agents which are included, added, etc., during the papermaking process before a fibrous paper substrate is formed. Internal paper sizing agents generally resist penetration of water or other liquids into the paper substrate by making the paper substrate more hydrophobic. Suitable internal paper sizing agents may include nonreactive surface sizing agents and reactive surface sizing agents.

For the purposes of the present invention, the term “nonreactive internal sizing agents” (also referred to interchangeably as “bulk internal sizing agents”) refer to internal surface sizing agents which are retained by the paper substrate primarily due to precipitation and electrostatic attraction to the paper fibers, and may be more suitable for acid-made paper substrates (i.e., paper substrates made from a paper fiber furnish having a pH value in, for example, the range of from about 3.5 to about 6.5, and which may be in the presence of an aluminum species, e.g. alum). Nonreactive internal surface sizing agents may include, for example, one or more of: rosin-based sizes (e.g., sizes formed from rosin acids isolated from the “tall oil” produced during kraft pulping of softwood species and which contain abietic acid and related compounds, and which may be treated with fumaric acid to convert at least some of the abietic acid and related compounds to tricarboxylic species referred to as “fortified rosin”) such as rosin emulsion sizes (i.e., rosin acids dissolved, dispersed, diluted, etc., with an emulsifier or stabilizer such as casein or other cationic polyelectrolyte to form a liquid), rosin soap sizes (e.g., salts of rosin acids which may be “set” in the presence of aluminum species, such as alum, to provide a water-soluble or water-dispersible solid); wax emulsion sizes (e.g., wax particles, such as from polyethylene (PE), polypropylene (PP), camuba, other natural or synthetic waxes, etc, suspended in an aqueous (water) phase); etc. See G. A. Smook, Handbook for Pulp and Paper Technologists (2^{nd} Edition, 1992), page 221, the entire contents and disclosure of which is herein incorporated by reference, for a general description of rosin sizes and other nonreactive internal sizing agents.

For the purposes of the present invention, the term “reactive internal sizing agents” refers to internal sizing agents which are retained by the paper substrate through reaction with the paper fibers, and may be more suitable for alkaline-made paper substrates (i.e., paper substrates made from a paper fiber furnish having a pH value in, for example, the range of from about 7 to about 9). Reactive internal size agents may include one or more of: alkyl ketene dimers (AKDs); alkenyl succinic acid anhydrides (ASAs), etc. See G. A. Smook, Handbook for Pulp and Paper Technologists (2^{nd} Edition, 1992), page 222, the entire contents and disclosure of which is herein incorporated by reference, for a general description of reactive internal size agents.

For the purposes of the present invention, the term “surface sizing starch” refers to surface sizing agents for paper substrates which comprise one or more natural starches (i.e., unmodified starches obtained from plant sources such as maize, wheat, rice, potato, tapioca, etc.) such as cereal starches (e.g., corn starch, wheat starch, rice starch, potato starch, oat starch, rye starch, barley starch, millet sorghum starch, etc.) and non-cereal starches (e.g., tapioca starch, etc.), modified natural starches (e.g., ethylated starches, oxidized starches, such as oxidized corn starch, etc.), or combinations thereof. Modified starches (e.g., oxidized starches such as oxidized corn starch) may be obtained by one or more chemical treatments known in the paper sizing starch art, for example, by oxidation to convert some of —CH₂OH groups to —COOH groups, etc. In some cases the modified starch may have a small proportion of acetyl groups. Alternatively, the starch may be chemically modified to render it cationic (i.e., a cationic starch) or amphoteric (i.e., an amphoteric starch), i.e., with both cationic and anionic charges. The modified starches may also include starches converted to a starch ether, or a hydroxyalkylated starch by replacing some —OH groups with, for example, —OCH₂CH₂OH groups (i.e., a hydroxyethylated starch), —OCH₂CH₃ groups (i.e., an ethylated starch), —OCH₂CH₂CH₂OH groups (i.e., a propylated starch), etc.

For the purposes of the present invention, the term “non-starch hydrophobic surface sizing agent” refers to surface sizing agents other than surface sizing starches which may be optionally included in the surface size layer applied on, added to, etc., the surface of the formed fibrous paper substrate. Non-starch surface hydrophobic sizing agents generally resist penetration of water or other liquids (e.g., by providing water hold out) into the paper substrate by covering the paper substrate with a more hydrophobic film to, example: (1) limit penetration of the subsequently applied hydrophobic pigmented coating (HPC) layer into the paper substrate when the HPC layer is applied, so less of the HPC is lost in the interior of the paper substrate, and (2) by contributing to the water barrier (holdout) properties of the paper substrate, the surface sizing layer may contribute to the benefits provided by the HPC layer, thus meaning thinner HPC layer may be required to achieve the same or similar Cobb values (as defined below). Suitable non-starch hydrophobic surface sizing agents may be, for example, anhydrides, dimers, polymers, copolymers, polymer latexes, etc., and may include, for example, one or more of: styrene-maleic anhydride (SMA) copolymers; styrene-acrylic (SA) copolymers, such as styrene-acrylic acid (SAA) copolymers; alkylated melamines; rosin-based sizes (e.g., rosin emulsion sizes, rosin soap sizes, etc.); styrene-butadiene (SB) copolymers; acrylonitrile-butadiene (AB) copolymers; alkyl ketene dimers (AKDs); polyacrylamides polymers or copolymers; etc.

For the purposes of the present invention, the term “paper pigments” refers to mineral pigments (e.g., calcium carbonate, clay (e.g., kaolin clay), talc, etc.), as well as non-mineral materials (e.g., plastic pigments, etc.), which may be used in paper making to reduce materials cost per unit mass of the paper substrate, increase opacity, increase smoothness, etc. The mineral pigments may be finely divided, for example, in the size range of from about 0.5 to about 5 microns, may be platy mineral pigments, etc.

For the purposes of the present invention, the term “calcium carbonate” refers various calcium carbonates which may be used as paper pigments, such as precipitated calcium carbonate (PCC), ground calcium carbonate (GCC), modified PCC and/or GCC, etc.

For the purposes of the present invention, the term “basis weight” refers to the grammage of a sheet, roll, etc., of material comprising the paper substrate, with or without layers or coatings, as determined by TAPPI test T410. See G. A. Smook, Handbook for Pulp and Paper Technologists (2^{nd} Edition, 1992), page 342, Table 22-11, the entire contents and disclosure of which is herein incorporated by reference, which describes the physical test for measuring basis weight. The basis weight of the paper substrate is essentially a measure of the density of that paper substrate per unit area, herein reflected in units of lbs/3000 ft² (3 msf). Suitable basis weights for use herein are in the range of from about 105 to about 300 lbs/3000 ft² (3 msf), such as from about 140 to about 250 lbs/3000 ft² (3 msf).

For the purposes of the present invention, the term “caliper,” refers to the thickness of a sheet, web, substrate, etc., of a material, for example, a material comprising the paper web, paper substrate, etc., with or without layers, coatings, etc., before or after calendaring, in mils, as determined by measuring the distance between smooth, flat plates at a defined pressure.

For the purposes of the present invention, the term “mil(s)” is used in the conventional sense of referring to thousandths of an inch and is also referred to interchangeably herein as “points.”

For the purposes of the present invention, the term “MD” refers to machine direction of the paper substrate, i.e., is used in the conventional papermaking sense of the direction the paper substrate moved during its formation.

For the purposes of the present invention, the term “CD” refers to the cross-machine direction, i.e., is used in the conventional papermaking sense of the direction transverse (e.g., orthogonal) to the machine direction (MD).

For the purposes of the present invention, the term “solids basis” refers to the weight percentage (or parts) of each of the respective solid materials (e.g., paper fibers, internal sizing agents, surface sizing agents, paper pigments, coating materials, polymers, etc.) present in the composition, etc., in the absence of any liquids (e.g., water, other solvents, etc.). Unless otherwise specified, all percentages and parts given herein for the solid materials are on a solids basis.

For the purposes of the present invention, the term “lbs/3000 ft² (used interchangeably with the term lbs/3 msf)” refers to the amount (in lbs) of the composition, compound, layer, component, material, etc., per unit of surface area (in 3000 ft² or 3 msf) of the one side, surface, etc., of the layer, paper substrate, coating, etc., that the composition, compound, layer, component, material, etc., is applied to, on, etc.

For the purpose of the present invention, the term “applying” with reference to the coatings, and compositions used to provide such coatings, may include adding, depositing, spraying, daubing, spreading, wiping, dabbing, dipping, printing, etc.

For the purposes of the present invention, the term “Cobb value” refers to a measure of water absorptiveness by the paper substrate/coated paper substrate. Cobb values reflect the mass of water absorbed in a specific period of time by a 1 m² sample of the paper substrate/coated paper substrate under specified conditions by a standard test method such TAPPI T-441. For embodiments of the coated paper substrates of the present invention, Cobb values may be measured in periods of 2 minutes or 30 minutes depending upon the coated paper substrate involved.

For the purposes of the present invention, the term “surface size composition” (also referred to in certain embodiments as a “size press composition”) refers to a size composition comprising: one or more surface sizing starches; optionally one or more non-starch hydrophobic surface sizing agents; optionally one or more paper pigments, etc., as well as one or more other optional ingredients such as pigment binders (e.g., polyvinyl alcohol, polyvinyl acetate, polyvinyl pyrrolidone polymers or copolymers, etc.), crosslinkers (e.g., glyoxals, ammonium zirconium carbonate (AZC), potassium zirconium carbonate (KZC), etc.), rheology modifiers, defoamers, etc.

For the purposes of the present invention, the term “surface size layer” (also referred to in some embodiments as “size press layer”) refers to one or more layers formed on (i.e., adjacent to) one or both surfaces or sides of the paper substrate by applying a surface size composition.

For the purposes of the present invention, the term “paper surface sizing device” refers to those devices, apparatus, machines, etc., which may be used to treat, apply, coat, etc., surface size compositions to one or more surfaces of a paper substrate. Paper surface sizing devices may include air-knife coaters, rod coaters, blade coaters, size presses, dip coaters, slot extrusion coaters, etc. See G. A. Smook, Handbook for Pulp and Paper Technologists (2^{nd} Edition, 1992), pages 283-94, the entire contents and disclosure of which is herein incorporated by reference, for a general description of size presses, coaters, etc., that may be useful herein. Size presses may include a puddle size press, a metering size press, etc. See G. A. Smook, Handbook for Pulp and Paper Technologists (2^{nd} Edition, 1992), pages 283-85, the entire contents and disclosure of which is herein incorporated by reference, for a general description of size presses that may be useful herein.

For the purposes of the present invention, the term “metering size press” refers to a size press that includes a component for spreading, metering, etc., deposited, applied, etc., the surface size composition on a paper substrate side or surface. Metering size presses may include a rod metering size press, a gated roll metering size press, a doctor blade metering size press, etc.

For the purposes of the present invention, the term “rod metering size press” refers to metering size press that uses a rod to spread, meter, etc., the surface size composition on the paper substrate surface. The rod may be stationary or movable relative to the paper substrate.

For the purposes of the present invention, the term “gated roll metering size press” refers to a metering size press that may use a gated roll, transfer roll, soft applicator roll, etc. The gated roll, transfer roll, soft applicator roll, etc., may be stationery relative to the paper substrate, may rotate relative to the paper substrate, etc.

For the purposes of the present invention, the term “hydrophobic pigmented coating composition” (also referred interchangeably as a “hydrophobic base coat composition”) refers to a coating composition comprising: a paper pigment component; a hydrophobic pigment binder component; etc., as well as one or more optional components such as water-dispersible emulsion polymers (as described below); rheology modifiers; optical brighteners (OBAs); defoamers; dispersants; etc.

For the purposes of the present invention, the term “hydrophobic pigmented coating layer” (also referred interchangeably as a “hydrophobic base coat layer” or “HPC layer”) refers to refers to one or more layers formed on (i.e., adjacent to) one or both surfaces of surface size coating layer(s) by applying of a hydrophobic pigment coating composition. Devices which may be use to apply these hydrophobic pigmented coating layers may include one or more of: air-knife coaters, rod coaters, blade coaters, curtain coaters, cascade coaters, dip coaters, slot extrusion coaters, etc.

For the purposes of the present invention, the term “paper pigment component” refers to a paper pigment component comprising: one or more platy mineral pigments; optionally one or more non-platy paper pigments; etc.

For the purposes of the present invention, the term “hydrophobic pigment binder component” refers to a binder component for the pigment component which comprises one or more hydrophobic polymers. These hydrophobic polymers may in the form of a latex, may be homopolymers or copolymers, and may include one or more of: styrene-butadiene (SB) copolymers; styrene-acrylic (SA) copolymers; styrene-acrylic-acrylonitrile (SAN) copolymers; polyvinyl acetate polymers; polyethylene (PE) polymers, including copolymers thereof; polypropylene (PP) polymers, including copolymers thereof, polyethylene terephthalate (PET) polymers, including copolymers thereof; waxes; polyurethane polymers; epoxy resins; etc.

For the purposes of the present invention, the term “moisture barrier coating composition” (also referred to interchangeably as the “topcoat composition”) refers to an aqueous emulsion coating composition imparting moisture barrier (hydrophobicity) benefits to the coated paper substrate, and which comprises: one or more water-dispersible emulsion polymers; an aqueous solvent (e.g., water), etc., as well as one or more optional ingredients, such as rheology modifiers, defoamers, coefficient of friction (COF) modifiers, heat-sealing aid, adhesive aids, anti-blocking aids (which may include pigments) for inhibiting the surfaces of coated paper substrates from sticking together (e.g., during pick or pull off on the rollers, during formation into rolls of coated paper substrate, etc.), etc.

For the purposes of the present invention, the term “moisture barrier coating layer” (also referred to interchangeably as a “topcoat layer”) refers to one or more outer layers formed from a moisture barrier coating composition, and wherein the one or more outer layers are formed on (i.e., adjacent to) the hydrophobic pigmented coating layer(s) by applying a moisture barrier coating composition. This moisture barrier coating layer may also be heat-sealable so that the resulting moisture barrier coated paper substrate may be used in making, for example, disposable cups, by using, for example, standard heat-seal cup forming equipment.

For the purposes of the present invention, the term “water-dispersible emulsion polymers” refers to polymers or copolymers which are dispersible in aqueous solvents (e.g., water) to form an aqueous polymer emulsion, and which may form a heat-sealable hydrophobic moisture barrier layer when dried (heated). These water-dispersible emulsion polymers should provide polymer particles that coalesce into a continuous film at normal drying temperatures employed in papermaking, should be heat-sealable at temperatures and seal times comparable to or in the range of, for example, low density polyethylene (LDPE), polyethylene terephthalate (PET), etc., should be safe for contact with foods or beverages (for those embodiments of the coated paper substrate to be used with foods or beverages), etc. Water-dispersible emulsion polymers suitable in embodiments of the present invention may include one or more of: polyethylene (PE) polymers (e.g., low density polyethylene (LDPE)), including copolymers thereof; polyethylene terephthalate (PET) polymers, including copolymers thereof; polyhydroxyalkanoate (PHA) polymers; polylactic acid (PLA) polymers; polyglycolic acid (PGA) polymers; polyvinyl acetate polymers; waxes; polyurethane polymers; epoxy resins; etc.

For the purposes of the present invention, the term “polyethylene (PE) polymers” refers to polyethylene (PE) polymers or copolymers which may be low density (LDPE) or high density (HDPE), and which may be formed as emulsions for providing the moisture barrier coating layer. Suitable commercially available PE polymer emulsions may include high density polyethylene (HDPE), as well as low density polyethylene (LDPE) emulsions available, for example, Coating X300 from Michelman, MD-80 from Omnova, Berchem 4000 from Bercen, etc.

For the purposes of the present invention, the term “polyethylene terephthalate (PET) polymers” refers to polyethylene terephthalate (PET) polymers or copolymers which may be formed as emulsions for providing the moisture barrier coating layer. Suitable commercially available PET polymer emulsions or modified PET emulsions may include EvCote Water Barrier 3000 from AkzoNobel, SFS 230HS and 250HS from Sustainable Fiber Solutions, etc.

For the purposes of the present invention, the term “polyhydroxyalkanoate (PHA) polymers” refers to biodegradable thermoplastic aliphatic polyesters which may be produced by polymerization of the respective monomer hydroxy aliphatic acids (including dimers of the hydroxy aliphatic acids), by bacterial fermentation of starch, sugars, lipids, etc. PHAs may include one or more of: poly-beta-hydroxybutyrate (PHB) (also known as poly-3-hydroxybutyrate); poly-alpha-hydroxybutyrate (also known as poly-2-hydroxybutyrate); poly-3-hydroxypropionate; poly-3-hydroxyvalerate; poly-4-hydroxybutyrate; poly-4-hydroxyvalerate; poly-5-hydroxyvalerate; poly-3-hydroxyhexanoate; poly-4-hydroxyhexanoate; poly-6-hydroxyhexanoate; polyhydroxybutyrate-valerate (PHBV); etc., including copolymers, blends, mixtures, combinations, etc., of different PHA polymers, etc. PHAs may be synthesized by methods disclosed in, for example, U.S. Pat. No. 7,267,794 (Kozaki et al.), issued Sep. 11, 2007; U.S. Pat. No. 7,276,361 (Doi et al.), issued Oct. 2, 2007; U.S. Pat. No. 7,208,535 (Asrar et al.), issued Apr. 24, 2007; U.S. Pat. No. 7,176,349 (Dhugga et al.), issued Feb. 13, 2007; and U.S. Pat. No. 7,025,908 (Williams et al.), issued Apr. 11, 2006, the entire disclosure and contents of the foregoing documents being herein incorporated by reference.

For the purposes of the present invention, the term “recyclable” refers to refers to compositions, compounds, substances, materials, paper substrates (e.g., coated paper substrates), etc., which may be reused as is or after reprocessing (e.g., composting, other chemical processing, etc.) in preparing new compositions, compounds, substances, materials, paper substrates, etc. The term “recyclable” includes the term “repulpable.”

For the purposes of the present invention, the term “repulpable” refers to compositions, compounds, substances, materials, paper substrates, (e.g., coated paper substrates), etc., which may be reused as is or after reprocessing (e.g., composting, other chemical processing, etc.) in papermaking.

For the purposes of the present invention, the term “comprising” means various compounds, components, polymers, ingredients, substances, materials, layers, steps, etc., may be conjointly employed in embodiments of the present invention. Accordingly, the term “comprising” encompasses the more restrictive terms “consisting essentially of” and “consisting of.”

For the purposes of the present invention, the term “and/or” means that one or more of the various compositions, compounds, polymers, ingredients, substances, materials, layers, steps, etc., may be employed in embodiments of the present invention.

For the purposes of the present invention, the definitions of the common testing methods are:

### Basis Weight: Tappi T410, “Grammage of Paper and Paperboard”

The area of several sheets of paper or paperboard is determined from lineal measurements and the mass (commonly called “weight”) is determined by weighing. The grammage is calculated from the ratio of the mass to the area after conversion to metric units when necessary. Unit is pounds per thousand square feet.

### STFI (Stiffness): Tappi T826, “Short Span Compressive Strength of Containerboard”

This measures edgewise compression strength. The standard describes a procedure for determining the compressive resistance of containerboard.

Method: A test specimen 15 mm wide (0.59″) is clamped between two clamps 0.7 mm (0.0276″) apart. The clamps are forced towards each other until a compressive failure occurs.

The maximum force causes failure is measured.

### Mullen: Tappi T804, “Compression Test of Fibreboard Shipping Containers”

Describes how to determine the resistance of a fiberboard shipping container to compressive forces. Accomplished by placing the container between two flat platens, one of which is mechanically or hydraulically driven to compress the container. A recording device measures the force and deflection required to compress the container.

### Cobb: Tapp T441, “Water Absorptiveness of Sized (Non-Bibulous) Paper and Paperboard”

Describes a procedure for determining the quantity of water absorbed by non-bibulous paper and paperboard in a specified time under standard conditions. Calculated as the average weight of water absorbed in grams per square meter.

### Porosity: Tappi T460, “Air Resistance of Paper (Gurley Method)”

Measures the amount of time required for a certain volume of air to pass through a test specimen. The air pressure is generated by a gravity loaded cylinder that captures an air volume within a chamber using a liquid seal.

### Angle of Slide: Tappi T815, “Coefficient of Static Friction (Slide Angle) of Packaging Materials”.

Measures angle of slide using an inclined plane.

### Taber Scuff: Tappi T476, “Abrasion Loss of Paper and Paperboard (Taber-Type Test Method)”

Determines the resistance of surfaces of paper and paperboard to the action of abrasion, either wet or dry by measuring abrasion loss.

### Emveco Printability: Tappi T575

The Emveco stylus method (Tappi T575) is a metric that predicts flexographic printability more reliably than traditional air-leak methods. Consequently, papermakers can use the stylus method to reduce variability associated with less predictive metrics, and monitor the effect of paper machine clothing and roll condition on printability.

### ZDT: Tappi T541, “Internal Bond Strength of Paperboard (Z-Direction Tensile)”

Internal bond strength provides an indication of expected performance (example: strength of board in relation to glue bonding at carton side seams, and possible delamination on scoring, or use of high tack coatings).

### DESCRIPTION

As used throughout, all numerical ranges disclosed herein, it should be understood that every maximum numerical limitation given throughout this specification includes every lower numerical limitation, as if such lower numerical limitations were expressly written herein. In addition, every minimum numerical limitation given throughout this specification will include every higher numerical limitation, as if such higher numerical limitations were expressly written herein. Further, every numerical range given throughout this specification will include every narrower numerical range that falls within such broader numerical range and will also encompass each individual number within the numerical range, as if such narrower numerical ranges and individual numbers were all expressly written herein.

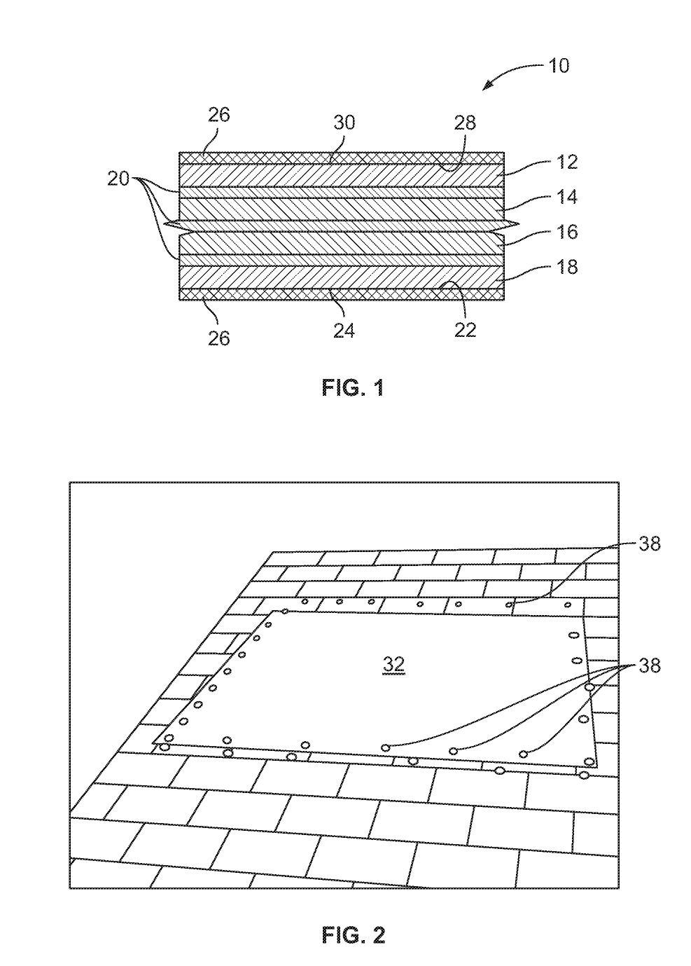

As depicted in FIG. 1, one aspect of the invention relates to a multi-ply coated paperboard 10. As an example in FIG. 1, the coated paperboard 10 comprises four plies, namely, a top ply 12, two intermediate plies 14, 16 and a base ply 18 all of which are made from solid fiber plies and laminated to one another with a water/moisture resistant adhesive 20 therebetween. However, one of ordinary skill in the art would appreciate that any number of plies can be used and it is within the scope of the invention. The base ply 18 includes inner and outer surfaces 22, 24 in which the outer surface 24 is coated with a water/moisture barrier coating layer 26. The top ply 12 includes inner and outer surfaces 28, 30 in which the outer surface 30 is coated with a water/moisture barrier coating layer 26. Each of the respective intermediate layers 14 and 16 is laminated to one another as well as to the respective inner surfaces 28 and 22 via water/moisture resistant adhesive 20. It is within the scope of the invention that an intermediate layer comprising a binder and a pigment is positioned between top ply 12 and base ply 18. However, in the broadest aspects of this invention any number of layers comprising binders and pigments or ligno cellulosic fibers can be positioned between plies 12 and 18 and intermediate layers 14 and 16.

The total basis weight of the multi-ply paperboard 10 may vary widely depending upon the intended function of the multi-ply paperboard 10 and any basis weight can be used.

In one example, the total basis weight of the multi-ply paperboard 10 may range from as low as about 20 lb per 1000 ft² or lower to about 300 lb per 1000 ft² or higher. In another example, the total basis weight of the multi-ply paper 10 may range from about 50 lb per 1000 ft² to about 200 lb per 1000 ft². As a further example, the total basis weight of the multi-ply paperboard 10 may range from about 100 lb per 1000 ft² to about 168 lb per 1000 ft². Finally, the total basis weight of the multi-ply paperboard 10 may be 42 lb per 1000 ft².

The caliper of the multi-ply paper or paperboard 10 may also vary widely depending on the application that the multi-ply paper is used and any caliper can be used. As an example, the caliper of the multi-ply paper 10 may have a range from about 0.01″ to about 0.05″ or higher. As another example, the caliper of the multi-ply paper 10 may have a range from about 0.03″ to 0.05″. As a further example, the caliper of the multi-ply paper 10 may have a range from about 0.044″ to 0.05″.

The relative basis weights of intermediate layers 14, 16, top ply 12 and base ply 18 may vary widely depending on the desired amount of top ply 12, base ply 18 and intermediate layers 14, 16 and the desired values for stiffness of respective ply.

The basis weights of base ply 18 and top ply 12 are the same or different and may vary widely and any basis weight can be used. For example, the basis weights of base ply 18 and top ply 12 can range from about 10 lb per 1000 ft² to about 300 lb per 1000 ft². For example, the basis weight of the base ply 18 may have a range from about 100 lb per 1000 ft² to about 170 lb per 1000 ft². As a further example, the basis weight of the base ply 18 may have a range from about 140 lb per 1000 ft² to about 168 lb per 1000 ft². Preferably, the basis weight of top ply 12 is the same as the basis weight of base ply 12 since either side of the coated paperboard can be used for the temporary roof patching.

The calipers of base ply 18, intermediate layers 14, 16 and top ply 12 may vary widely and any conventional calipers may be employed. In one example of the invention, calipers may have a range from about 0.01″ to about 0.05″ or higher. In another example, the caliper of the top ply 12 or base ply 18 may also have a range from about 0.03″ to 0.05″. In a further example, the caliper of top ply 12 or the base ply 12 may have a range from about 0.044″ to 0.05″. Each of the intermediate layers 14, 16 may have same or different caliper as compared to the top ply 12 and the base ply 18.

In some cases, the top ply 12 and the base ply 18 of the multi-ply paperboard 10 can be coated with a pigmented or non-pigmented formulation to improve appearance. While useful pigments may vary widely, illustrative of useful pigments are ground calcium carbonate or alternatively, clay or calcium sulfate. High compressive strength and good print quality are the primary required attributes for this paperboard.

The intermediate layers 14, 16 may include of one or more pigments dispersed in one or more binders. The basis weight of intermediate layers 14, 16 may vary widely and any basis weight can be used to provide the desired stiffness. Preferably, the basis weight of intermediate layers 14, 16 can a range from about 10 lb per 1000 ft² to about 200 lb per 1000 ft². For example, the basis weight of intermediate layers 14, 16 may have a range from about 30 lb per 1000 ft² to about 70 lb per 1000 ft². As a further example, the basis weight of intermediate layer 14, 16 may have a range from about 42 lb per 1000 ft² to about 110 lb per 1000 ft².

Referring to FIG. 1, the water repellent coating 26 is applied on the respective outer surfaces 24 and 30 of the respective base ply 18 and top ply 12, in which the paperboard patch performs like a shingle and keeps the water/moisture out of a home or other structure. The coating includes two layers of ClimaShield® 1092 which is also called double coating ClimaShield® 1100. The coating is an aqueous (water) dispersion of a propylene glycol ester and 1,3 Butadiene. The coated paperboard 10 imparts water/moisture and prevents or substantially reduces the Moisture Vapor Transmission Rate (MVTR) of the coating or coating barrier. The coating does not hinder the application of printable material after the coating and it will hot melt with inks and adhesives formulated for this coating.

The coating has a coat weight from 1-10 wet #'s total per MSF (thousand square feet). Alternatively, the coating has a coat weight less than 5 wet #'s total per MSF (thousand square feet). The coating is a composition of at least one member selected from the group consisting of a styrene butadiene resin, acrylic polymer, pigment, pulverized mica. The coated paperboard is readily recyclable and repulpable. Alternatively, the coating may also positioned at the inside surface of the linerboard.

The coating composition used in the present invention is those that may contain at least resin, cross linker, and anti-foam in any amount. The coating composition may contain from 0 to 99 wt %, preferably from 40 to 90 wt %, more preferably 50 to 80 wt %, and most preferably 60 to 80 wt % resin based on the total weight of the solids in the composition. This range may include 0, 0.25, 0.5, 1, 2, 3, 4, 5, 10, 15, 20, 25, 30, 35, 40, 45, 50, 55, 60, 65, 70, 75, 80, 85, 90, 100 wt % based on the total weight of the solids in the composition, including any and all ranges and subranges contained therein. In a preferred embodiment, the coating composition contains about 71.4 wt % of the resin based on the total weight of the solids in the composition.

The coating composition may contain from 0 to 90 wt %, preferably from 30 to 90 wt %, more preferably 50 to 80 wt %, and most preferably 60 to 80 wt % filler based on the total weight of the solids in the composition. This range may include 0, 0.25, 0.5, 1, 2, 3, 4, 5, 10, 15, 20, 25, 30, 35, 40, 45, 50, 55, 60, 65, 70, 75, 80, 85, 90, 100 wt % based on the total weight of the solids in the composition, including any and all ranges and subranges contained therein. In a preferred embodiment, the coating composition contains about 36.0 wt % of the filler based on the total weight of the solids in the composition.

The coating composition may contain from 0 to 30 wt %, preferably from 5 to 30 wt %, more preferably 10 to 20 wt %, and most preferably 15 to 20 wt % cross linker based on the total weight of the solids in the composition. This range may include 0, 0.25, 0.5, 1, 2, 3, 4, 5, 10, 15, 20, 25, and 30 wt % based on the total weight of the solids in the composition, including any and all ranges and subranges contained therein. In a preferred embodiment, the coating composition contains about 2.5 wt % of the filler based on the total weight of the solids in the composition.

The coating composition may contain from 0 to 3 wt %, preferably from 1 to 3 wt %, more preferably 1 to 2 wt %, and most preferably 0.1 to 1.0 wt % anti-foam based on the total weight of the solids in the composition. This range may include 0, 0.25, 0.5, 1, 1.5, 1.75, 2, 2.25, 2.5, 3 wt % based on the total weight of the solids in the composition, including any and all ranges and subranges contained therein. In a preferred embodiment, the coating composition contains about 0.1 wt % of the anti-foam based on the total weight of the solids in the composition.

The coated paperboard has a MVTR of less than 40 grams/m²/24 hours as measured by TAPPI Test Method T-448 om-89 at 72° F., 50% relative humidity. Alternatively, the coated corrugated linerboard has a MVTR of less than 20 grams/m²/24 hours as measured by TAPPI Test Method T-448 om-89 at 72° F., 50% relative humidity. Alternatively, the coated corrugated linerboard has a MVTR of less than 10 grams/m²/24 hours as measured by TAPPI Test Method T-448 om-89 at 72° F., 50% relative humidity.

The coated paperboard has a MVTR of less than 180 grams/m²/24 hours as measured by TAPPI Test Method T-448 om-89 at 90° F., 90% relative humidity. Alternatively, the coated corrugated linerboard has a MVTR of less than 100 grams/m²/24 hours as measured by TAPPI Test Method T-448 om-89 at 90° F., 90% relative humidity. Alternatively, the coated linerboard has a MVTR of less than 40 grams/m²/24 hours as measured by TAPPI Test Method T-448 om-89 at 90° F., 90% relative humidity.

The coated paperboard has a Cobb value of less than 200 g/cm² in 30 minutes as measured by TAPPI Test Method T-441. Preferably, the Cobb value is from about 25 to about 70 g/cm² in 2 minutes and more preferably, the Cobb value is from about 25 to about 75 g/cm² in 2 minutes and most preferably, the Cobb value is 155 g/cm² in 30 minutes.

As noted above, the top ply 12, two intermediate plies 14, 16 and the base ply 18 all of which are made from solid fiber substrate and laminated to one another with a water/moisture resistant adhesive 20 therebetween. The water/moisture resistant adhesive 20 is a formulated powdered adhesive designed primarily to glue paperboard and/or similar substrates.

The basic components of the water/moisture resistant adhesive are fully hydrolyzed polyvinyl alcohol (less than 90% dry basis) and boric acid (less than 15% dry basis) and other ingredients. The degree of hydrolysis of the polyvinyl alcohol is about 98%.

The water/moisture resistant adhesive is put into water solution by slowly adding about 10% to 15% into cold water with mixing and adjusting the temperature to 200 F with live steam (After adjusting the application temperature to 140 F with additional cold water and adjusting the % working solids to about 14%). Application to the paperboard is accomplished via various types of techniques such as rods or knives etc. Recommended application temperature is 140 F but can vary depending on equipment.

In addition to the above, experiments were conducted to evaluate the water/moisture resistance, strength, and the likes. It now appears that the water repellent characteristic of the coated paperboard relates to surface energy. The combination of the adhesive and the coating applied to the paperboard significantly reduces the surface energy of the coated paperboard far below the surface energy of the water and therefore, the water beads up rather than wet out, reducing its contact area with the surface of the coated paperboard. A sample of temporary roofing patch 32 made from a coated paperboard having both sides are coated in accordance to the present invention is shown in FIG. 2. The temporary roofing patch 32 is attached via roof nails 34 having plastic caps 36 to a portion of a roof 38. After more than 8 weeks under humid, wet and/or raining conditions, the coated paperboard is shown no leaking or any warping on the entire sample of temporary roofing patch 32. As noted above, the temporary roofing patches 32 can be tinted with different colors to match with the original color of the roof. Furthermore, the temporary roofing patches 32 can also be tinted with different colors on each side of the temporary roofing patches 32. For example, one side of the temporary roofing patches 32 can be gray and the opposed side can be black so that depending on the original color of the roof, the matching color side temporary roofing patches 32 can be utilized.

As noted hereinbefore, almost all of the grades coated paperboards have been used in making containers, cups, slip sheets, tier sheets, and the pallet sheets that are used for various purposes except the purpose or function of coated paperboard disclosed by the claimed invention. However, the present invention is directed to a coated paperboard 10 that can be used for temporary roof patching 32 as an alternative to the commonly used tarpaulin for patching roofs which provide temporary coverage after storms or during renovations. The coated paperboard temporary roof patch 32 only requires roof nails 36 to attach and is approximately 40″×48″ in size to avoid waste, make it easier to apply, less costly, and it is safer. The coated paperboard temporary patch is a solid fiber substrate or liners laminated together with a moisture resistant adhesive 20. The two respective outside top and base plies 12, 18 are coated with a moisture resistant coating 26 and tinted to blend with roofs as best as possible. The coated paperboard temporary roof patch 32 is attached with roof nails three shingles above the hole and with at least four inches of coverage around the hole on the other sides. It prevents water and other elements from entering the home/structure by patching the hole for a temporary period of time, such as for example, up to 60 days. The field testing and lab tests with coated paperboard show remarkable results. Inventors discovered that product that is paper-based and specific to the roofing industry is superior to the commonly used tarpaulins or tarps and/or plywood and the like. Because of the moisture resistant adhesives 20 used in the laminating process and the moisture resistant coatings 26 on the outside of the paperboard 10, the paperboard patch performs like a shingle and keep the water/moisture out of a home or other structure. Some of the notable advantages of the temporary paperboard roof patch are: safety, ease of use/handling, reduced waste, less costs, less labor/time to apply, ease of disposal, and biodegradable as opposed to petroleum based raw material such as tarpaulins or tarps.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. A coated paperboard comprising a top ply, at least one intermediate ply, and base ply, wherein the top, base and at least one intermediate play are laminated together with a moisture resistant adhesive and wherein the respective top and base plies are coated with a water or moisture resistant coating such that the coated paperboard is capable of being used as a temporary roofing patch for a damaged roof.

2. The coated paperboard of claim 1 wherein the top ply is laminated to a first intermediate ply, said first intermediate ply is laminated to a second intermediate ply and said second intermediate ply is laminated to the base ply.

3. The coated paperboard of claim 2 wherein each of the first and second plies comprises a binder and a pigment.

4. The coated paperboard of claim 1 wherein each of the top, base and intermediate plies comprise solid fiber.

5. The coated paperboard of claim 1 wherein the base and the top ply have inner and outer surfaces and said outer surface of at least one of the base and top plies is coated with moisture barrier coating.

6. The coated paperboard of claim 5 wherein the moisture barrier coating is an aqueous dispersion of propylene glycol ester and 1,3 Butadiene.

7. The coated paperboard of claim 6 wherein the moisture barrier coating has a coat weight from about 1 lb/1000 ft² to 10 lbs/1000 ft².

8. The coated paperboard of claim 5 wherein there are at least two layers of said moisture barrier coating applied to at least one of the base and top plies.

9. The coated paperboard of claim 1 wherein the basis weight of the paperboard is from about 20 lbs/1000 ft² to about 300 lbs/1000 ft².
